(19) United States
(12) Patent Application Publication
(10) Pub. No.: US 2012/0247152 A1
(43) Pub. Date: Oct. 4, 2012

(54) PROCESS FOR PRODUCING CHEMICALLY STRENGTHENED GLASS

(75) Inventors: Seiki Ohara, Tokyo (JP); Kazutaka Ono, Tokyo (JP); Masayuki Ishimaru, Tokyo (JP); Takuo Osuka, Tokyo (JP)

(73) Assignee: Asahi Glass Company, Limited, Chiyoda-ku (JP)

(21) Appl. No.: 13/434,044

(22) Filed: Mar. 29, 2012

(30) Foreign Application Priority Data
Mar. 31, 2011 (JP) 2011-077921

(51) Int. Cl. C03C 21/00

(52) U.S. Cl. 65/29.16

(57) ABSTRACT

The present invention relates to a process for producing a chemically strengthened glass, which includes conducting a sampling inspection including a measurement of a refractive index distribution of a glass. According to the process of the invention, the surface compressive stress and the depth of the compressive stress layer of the chemically strengthened glass can be stably and accurately measured.

### FIELD OF THE INVENTION

The present invention relates to a process for producing a chemically strengthened glass.

### BACKGROUND OF THE INVENTION

Recently, a chemically strengthened glass having an enhanced strength for the purpose of protection has been frequently used in mobile displays such as cell phones and PDA and flat panel displays such as large-size liquid televisions (see JP-A-57-205343, JP-A-9-236792 and JP-A-2009-84076). For representing properties of the chemically strengthened glass, it is common to use surface compressive stress and depth of a compressive stress layer as indices.

A chemically strengthened glass is produced, for example, by immersing a glass containing a Na ion (sodium ion) in a molten salt containing a K ion (potassium ion). When the glass is chemically strengthened, the Na ion in the glass surface layer is replaced with the K ion having an atomic weight larger than that of the Na ion and an electron thus becomes difficult to move, so that an optical refractive index increases in a chemically strengthened region. In the chemically strengthened glass in which the surface layer of the glass has been ion-exchanged, the optical refractive index in the surface layer increases but, as approaching inside, the refractive index is getting close to the refractive index of the bulk glass.

A light obliquely entering from the surface of a glass has a nature of propagating to a region having a higher refractive index and thus a light reflected at the glass surface and a light propagated inside the glass interfere with each other, so that fringes are observed. By observing the positions of the interference fringes in two polarization directions of a vertical direction and a horizontal direction, a value of the surface compressive stress can be determined through stress conversion using a photoelastic constant. Moreover, the depth of the compressive stress layer can be determined from the number of the interference fringes (see, “Optics and Lasers in Engineering 4” (1983), p. 25-38). A surface stress meter FSM-6000 has been commercialized by Orihara Industrial Co., Ltd. and has been widely used for stress measurement of glass.

However, in the case where the surface compressive stress and the depth of the compressive stress layer are measured by the surface stress meter with regard to a chemically strengthened glass, there is a problem that the positions, width, or number of the interference fringes are erroneously measured due to the occurrence of blurs and ghosts of the interference fringes and, as a result, the surface compressive stress and the depth of the compressive stress layer are erroneously measured.

### SUMMARY OF THE INVENTION

The present inventors have found that such instability in the measurement of the surface compressive stress and the depth of the compressive stress is attributable to homogeneity of glass, i.e., abnormality of the refractive index. Furthermore, they have found that, by chemically strengthening a glass having no refractive index distribution, the surface compressive stress and the depth of the compressive stress layer of the chemically strengthened glass obtained can be stably and accurately measured.

Namely, the present invention provides the following items 1 to 4.

1. A process for producing a chemically strengthened glass, comprising conducting a sampling inspection including a measurement of a refractive index distribution of a glass.

2. The process for producing a chemically strengthened glass according to item 1 above, further comprising chemically strengthening a glass found to have no refractive index distribution as a result of the measurement of the refractive index distribution in the sampling inspection.

3. The process for producing a chemically strengthened glass according to item 1 or 2 above, wherein the refractive index distribution is measured by means of a two-beam interferometer.

4. The process for producing a chemically strengthened glass according to any one of items 1 to 3 above, further comprising measuring a surface compressive stress and a depth of a compressive stress layer of a chemically strengthened glass in a non-destructive manner.

According to the production process of the invention, by a sampling inspection including measuring refractive index distribution of a glass, a glass belonging to a lot having no abnormality in refractive index of the glass can be subjected to a chemical strengthening. By subjecting the glass belonging to a lot having no abnormality in refractive index of the glass to a chemical strengthening, the surface compressive stress and the depth of the compressive stress layer of the chemically strengthened glass obtained can be stably and accurately measured and thus it becomes possible to achieve stabilization, homogenization, and improvement of the quality of the chemically strengthened glass.

### BRIEF DESCRIPTION OF THE DRAWINGS

FIG. 1 shows a process for preparing a glass sample to be subjected to a measurement of refractive index distribution with a two-beam interferometer.

FIG. 2A shows an image obtained by a measurement of a normal article with a surface stress meter. FIG. 2B shows an image obtained by a measurement of an abnormal article with a surface stress meter.

FIG. 3A to FIG. 3C show measurement results of refractive index distribution of abnormal articles. FIG. 3D and FIG. 3E show measurement results of refractive index distribution of normal articles.

### DETAILED DESCRIPTION OF THE INVENTION

The following will describe the invention in detail but the invention is not limited thereto.

In the production process of the invention, a chemically strengthened glass can be produced by a conventional process except that the production process of the invention includes a step of a sampling inspection including measuring a refractive index distribution of a glass.

### Process for Producing Glass Before Chemical Strengthening

In the production process of the invention, a glass to be subjected to the chemical strengthening can be produced by charging desired glass raw materials into a continuous melting furnace, melting the glass raw materials preferably at 1500 to 1600° C., and, after clarification, feeding the molten glass to a forming apparatus and forming the molten glass into a plate shape, followed by annealing. The composition of the glass to be produced in the production process of the invention is not particularly limited.

Incidentally, for the forming of a glass substrate, various processes may be adopted. For example, various forming processes such as downdraw processes (e.g., an overflow downdraw process, a slot downdraw process, and a redraw process, etc.), a float process, a roll-out process, and a pressing process may be adopted.

The production process of the invention may include a polishing step of polishing the glass produced by the aforementioned production process with a polishing pad with feeding a polishing slurry, according to needs. As the polishing slurry, a polishing slurry containing an abrasive and water can be used. As the abrasive, cerium oxide (ceria) and silica are preferable.

The production process of the invention may include a cleaning step of cleaning the glass polished in the aforementioned polishing step with a cleaning liquid. A neutral detergent and water are preferable as the cleaning liquid, and it is more preferable to wash the glass with the neutral detergent, followed by washing with water. As the neutral detergent, commercially available ones can be used.

Moreover, as a final cleaning step, the process may include a step of washing the glass washed in the aforementioned cleaning step with a cleaning liquid. As the cleaning liquid for the final cleaning step, for example, water, ethanol, and isopropanol may be mentioned. Of these, water is preferable.

The glass cleaned in the aforementioned final cleaning step is subjected to a drying step where the glass is dried with heating. In the production process of the invention, the drying step is an arbitrary step which may be adopted according to needs. As drying conditions in the drying step, most suitable conditions may be selected with considering the cleaning liquid used in the cleaning step, properties of the glass, and the like.

### Sampling Inspection

The process for producing a chemically strengthened glass of the invention includes a step of a sampling inspection including measuring a refractive index distribution of a glass. In the invention, the term “sampling inspection” means an inspection method where a part of glass constituting a lot is sampled in accordance with a predetermined procedure and subjected to a test (inspection), and the result is compared with the criteria to determine acceptance or rejection of the lot.

Conditions for the sampling inspection can be appropriately adjusted depending on the composition of the glass, the conditions for the chemical strengthening, and the like. For example, the inspection can be performed in accordance with JIS Z 9015.

In the invention, although the refraction index distribution of the glass may be measured before or after the chemical strengthening step, it is preferred to measure the refraction index distribution before the chemical strengthening step from the viewpoint of economic efficiency.

The region having a different refractive index is a region having a different glass composition and, for example, is a layer where the concentration of zirconia or aluminum that is a brick component is rich. In the chemical strengthening treatment, for example, a Na ion and a K ion are continuously exchanged at the surface of the glass. However, the compositional unevenness before the chemical strengthening remains even after the chemical strengthening and the refraction index distribution before the chemical strengthening is reflected even after the chemical strengthening.

As measurement methods of the refractive index distribution of glass, for example, there may be mentioned a method of measuring an angle of deviation by a minimum deviation method or the like to determine the refractive index, a method of measuring transmitted wavefront by configuring an interferometer to determine the refractive index distribution, and the like. Additionally, the refractive index distribution may be determined by a schlieren method.

For measuring the refractive index distribution of a minute region present in a thickness direction of a glass plate, it is preferred to measure the distribution by means of a two-beam interferometer having both functions as a microscope and as an interferometer.

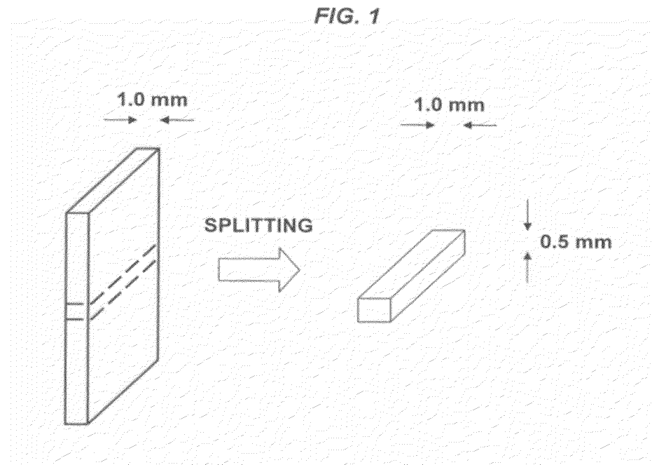

As a method for preparing a glass sample to be subjected to the measurement of the refractive index distribution in the two-beam interferometer, specifically, for example, it is preferred to cut the glass and mirror polish the resulting sample into a thickness of 0.5 mm so that the cross-sectional direction can be observed. A specific example of the method for preparing the sample is illustrated in FIG. 1.

The two-beam interferometer measures the refractive index distribution in accordance with the following principle. When a light outgoing from the same light source is separated into two lights and the two lights are superimposed after the lights pass through separate optical paths, interference is generated to show light and dark fringes if a phase shifting is present between the respective optical paths.

By setting a transparent article to be inspected (glass) in one optical path, an optical phase shifting is observed by a shift of the interference fringes and is obtained as a product of the refractive index and the distance. Since one fringe corresponds to the wavelength of the light, it becomes possible to quantitatively determine density distribution by observing a degree of the shift of the interference fringe or an isopycnic interference fringe.

Since optical path length (distance which light travels as a converted value in vacuum) is an integral value of the product of the propagated distance and the refractive index (integral value of “propagated distance×refractive index”), the optical path length reflects a refractive index profile in the case where the thickness of the article to be measured is even. The optical phase shifting is “2π×Optical path length difference/Light wavelength” and the refractive index profile induces the optical phase shifting and is reflected in the interference fringes.

A glass ideally produced by a float process or the like has a homogeneous composition and thus the refractive index is even. However, when a glass base material in which brick composing a furnace is dissolved or a staying glass material having a different composition is mixed, a region having a different refractive index is generated due to the difference in glass composition, resulting in a generation of a refractive index distribution inside the glass.

In the invention, in the case where the glass has no refractive index distribution as a result of the measurement by the sampling inspection, it is judged that it is possible to measure the surface compressive stress and the depth of the compressive stress layer of the chemically strengthened glass accurately by a non-destructive measurement method.

In the invention, the expression “has (having) no refractive index distribution” means that the refractive index distribution of a chemically strengthened glass measured by means of a two-beam interferometer is lower than the detection limit of the two-beam interferometer. It is preferred that the detection limit of the refractive index distribution measured by means of the two-beam interferometer is typically 0.0001 or less.

### Chemical Strengthening Step

In the invention, it is preferred to chemically strengthen a glass belonging to a lot having no refractive index distribution as a result of measuring the refractive index distribution of the glass by the aforementioned sampling inspection.

By chemically strengthening the glass belonging to a lot having no refractive index distribution, in the stress measurement using a surface stress meter, the surface compressive stress and the depth of the compressive stress layer of the chemically strengthened glass can be accurately measured without erroneously observing the positions or the number of the interference fringes of the chemically strengthened glass obtained and hence a chemically strengthened glass having desired surface compressive stress and depth of the compressive stress layer can be obtained.

The chemical strengthening step includes an ion exchange step and frequently includes a preheating step before the ion exchange step. The preheating step is a step where a glass substrate after the drying step is heated to a predetermined preheating temperature.

As conditions for the preheating, most suitable conditions may be selected with considering the properties of the glass, molten salts to be used in the ion exchange step, and the like. As specific conditions, for example, the preheating temperature is preferably from 300 to 400° C. Moreover, preheating time is preferably from 2 to 6 hours.

The ion exchange step is a step where an alkaline ion having a small ionic radius (e.g., a sodium ion) on the glass surface is replaced with an alkali ion having a large ionic radius (e.g., a potassium ion). The ion exchange step is performed, for example, by treating a glass containing a sodium ion with a molten salt containing a potassium ion.

The chemical strengthening (ion exchange) treatment can be performed, for example, by immersing a glass in a potassium nitrate solution at 400 to 550° C. for 1 to 8 hours. As conditions for the ion exchange, most suitable conditions may be selected with considering viscosity properties, uses, and plate thickness of the glass, tensile stress inside the glass, and the like.

As the molten salt for performing the chemical strengthening treatment, for example, there may be mentioned alkali nitrates, alkali sulfates and alkali chlorides, such as sodium nitrate, potassium nitrate, sodium sulfate, potassium sulfate, sodium chloride, and potassium chloride. These molten salts may be used singly or plural thereof may be used in combination.

In the invention, treatment conditions for the chemical strengthening treatment are not particularly limited and most suitable conditions may be selected with considering properties of the glass, the molten salt, and the like.

Heating temperature of the molten salt is typically preferably 350° C. or higher, more preferably 380° C. or higher. Moreover, it is preferably 500° C. or lower, more preferably 480° C. or lower. By controlling the heating temperature of the molten salt to 350° C. or higher, difficulty in achievement of the chemical strengthening due to a decrease in ion exchange rate is prevented. Moreover, decomposition/deterioration of the molten salt can be suppressed by controlling the temperature to 500° C. or lower.

A period of time for bringing the glass into contact with the molten salt is typically preferably 1 hour or longer, more preferably 2 hours or longer for the purpose of imparting a sufficient compressive stress. Moreover, since the ion exchange for a long period of time decreases productivity and also lowers the compressive stress value due to relaxation, the period is preferably 24 hours or shorter, more preferably 20 hours or shorter.

### Measurement of Surface Compressive Stress and Depth of Compressive Stress Layer of Chemically Strengthened Glass

In the process of the invention, it is preferred to measure the surface compressive stress and the depth of the compressive stress layer of the chemically strengthened glass in a non-destructive manner. As a method of measuring the surface compressive stress and the depth of the compressive stress layer of the chemically strengthened glass in a non-destructive manner, for example, there may be mentioned a method of measuring the surface stress utilizing an optical waveguiding effect. As an apparatus for measuring the surface stress utilizing an optical waveguiding effect, a surface stress meter FSM-6000 (manufactured by Orihara Industrial Co., Ltd.) has been widely used.

When a region where a refractive index distribution is generated is present inside the glass, a light propagating path changes in the region. In the stress measurement using the surface stress meter, a light reflected on the glass surface and a light propagated inside the glass are interfered with each other to show fringes.

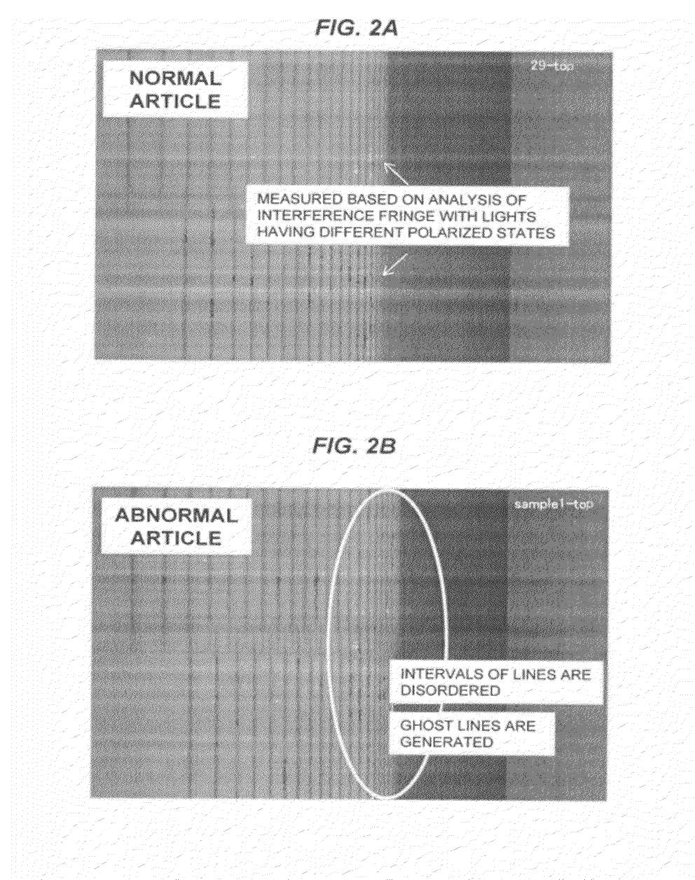

Therefore, due to the presence of the region where a refractive index distribution is generated, in the stress measurement using the surface stress meter, there is a possibility that interference fringes occur in positions different from the positions to be intrinsically present and some interference fringes overlap with other interference fringes or the intervals are disordered. FIG. 2A shows an image of interference fringes of a normal article and FIG. 2B shows an image of interference fringes of an abnormal article where a refractive index distribution is generated. In the abnormal article shown in FIG. 2B, as compared with the interference fringes in the normal article shown in FIG. 2A, it is understood that the line intervals are disordered and ghost lines are generated.

In the stress measurement using the surface stress meter, as a result of the occurrence of the interference fringes in the positions different from the positions to be intrinsically present, overlapping with other interference fringes, and the disorder of the intervals, there is a risk that the surface compressive stress or the depth of the compressive stress layer is erroneously measured due to erroneous observation of the positions or the number of the interference fringes.

Accordingly, in order to accurately measure the surface compressive stress and the depth of the compressive stress layer of a chemically strengthened glass by the measurement method of non-destructive measurement, it is preferred to chemically strengthen a glass found to have a refractive index distribution of preferably 0.0001 or less, more preferably having no refractive index distribution in the aforementioned sampling inspection step.

### EXAMPLES

The following will describe the invention with reference to Examples but the invention is not limited thereto.

### (Glass Composition)

As the glass to be subjected to chemical strengthening, a glass having a composition (% by mol) containing 64.2% of SiO₂, 6.0% of Al₂O₃, 11.0% of MgO, 0.1% of CaO, 0.1% of SrO, 0.1% of BaO, 2.5% of ZrO₂, 12.0% of Na₂O, and 4.0% of K₂O in terms of % by mol was used.

### Chemical Strengthening

After the above-mentioned glass was preheated at 350° C. for 4 hours, an ion exchange treatment was performed at 450° C. for 6 hours using KNO₃ as a molten salt to obtain a chemically strengthened glass.

Measurement of Refractive Index Distribution

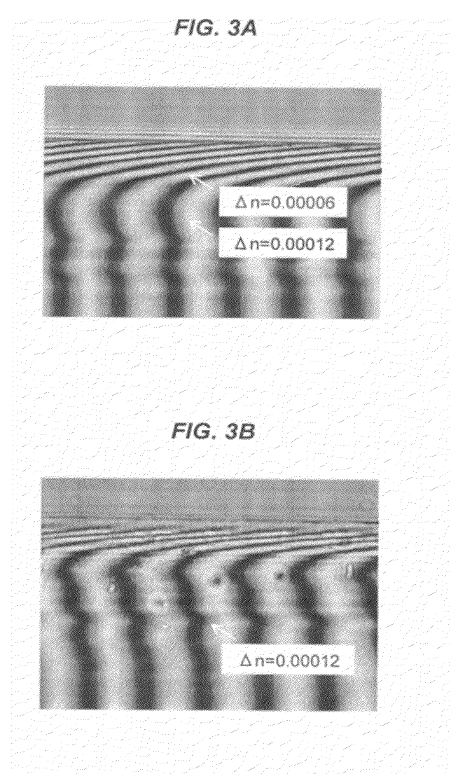

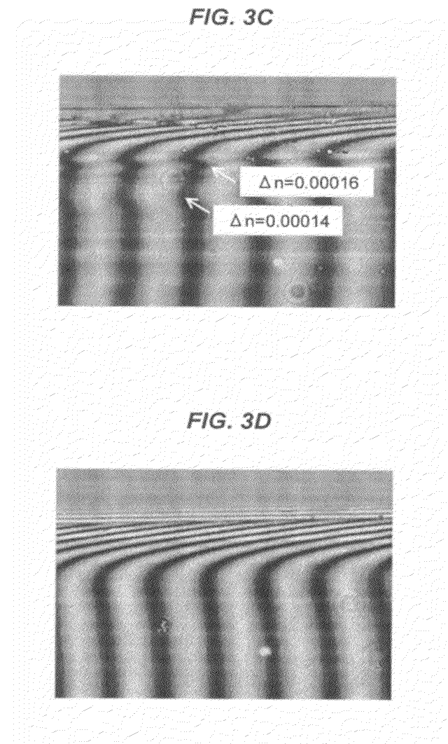

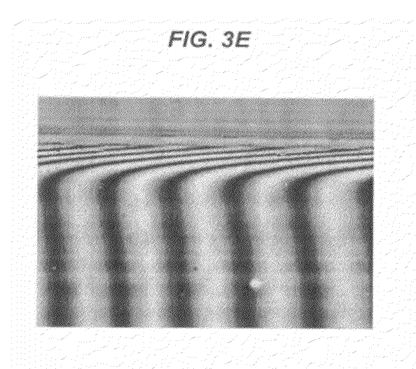

As shown in FIG. 1, the chemically strengthened glass obtained was cut and mirror-polished into 0.5 mm so that the cross-sectional direction could be observed and then the refractive index distribution was measured with a two-beam interferometer (Mach-Zehnder interferometer, Mizojiri Optical Co., Ltd.). The results are shown in Table 1 and FIGS. 3A to 3E.

In Table 1 and FIGS. 3A to 3E, Examples 1 to 3 (FIG. 3A to FIG. 3C) are abnormal articles and Examples 4 and 5 (FIG. 3D and FIG. 3E) are normal articles. As shown in Table 1 and FIGS. 3A to 3E, it was revealed that fluctuation of the refractive index occurred and a refractive index distribution was generated in Examples 1 to 3 that are abnormal articles, while the refractive index was not fluctuated and no refractive index distribution was generated in Examples 4 and 5 that are normal articles (shown as “absent” in Table 1).

As mentioned in the above, since the compositional unevenness before the chemical strengthening remains even after the chemical strengthening and the refractive index distribution before the chemical strengthening is reflected even after the chemical strengthening, the refractive index distribution in the glass after the chemical strengthening measured in each Example is equal to the refractive index distribution in the glass before the chemical strengthening.

### Measurement of Surface Stress

A glass plate having the aforementioned composition, which was mirror-polished into a thickness of 1.0 mm, was chemically strengthened under the above-described conditions. For Side A (front face) and Side B (reverse face) of each glass, surface stress (compressive stress) and stress depth (depth of compressive stress layer) were measured using a surface stress meter FSM-6000 manufactured by Orihara Industrial Co., Ltd. The results are shown in Table 1. Also, the ratio of difference between the values of Side A and Side B (Delta=(100×Absolute value of difference between values of Side A and Side B/Average value of Side A and Side B) is shown.

TABLE 1

| | | Side A | | Side B | | Delta | |
|---|---|---|---|---|---|---|---|
| | Refractive | | Stress | | Stress | | Stress |
| | index | Compressive | depth | Compressive | depth | Compressive | depth |
| | distribution | stress (MPa) | (μm) | stress (MPa) | (μm) | stress (%) | (%) |
| Example 1 | 0.00012 | 621 | 49 | 621 | 56 | 0.0 | 13.3 |
| Example 2 | 0.00012 | 578 | 46 | 577 | 50 | 0.2 | 8.3 |
| Example 3 | 0.00016 | 667 | 46 | 663 | 51 | 0.6 | 10.3 |
| Example 4 | absent | 607 | 56.7 | 614 | 57.1 | 1.1 | 0.7 |
| Example 5 | absent | 619 | 56.8 | 625 | 56.8 | 1 | 0.0 |

As shown in Table 1, in Examples 1 to 3 where the fluctuation of the refractive index occurred, the refractive index distribution is 0.0001 or more, and abnormality in the refractive index distribution was generated, Delta for stress depth between Side A (front face) and Side B (reverse face) of the same glass was so large as 8% or more. On the other hand, in Examples 4 and 5 where the fluctuation of the refractive index was absent and no refractive index distribution was generated, Delta for stress depth between Side A (front face) and Side B (reverse face) of the same glass was 1% or less.

From the results, it was understood that, for a chemically strengthened glass obtained from a glass having no abnormality in refractive index distribution, the surface compressive stress and the depth of the compressive stress can be stably and accurately measured by a non-destructive measurement method.

While the invention has been described in detail and with reference to specific embodiments thereof, it will be apparent to one skilled in the art that various changes and modifications can be made therein without departing from the scope thereof.

This application is based on Japanese patent application No. 2011-077921 filed Mar. 31, 2011, the entire contents thereof being hereby incorporated by reference.

What is claimed is:

1. A process for producing a chemically strengthened glass, comprising conducting a sampling inspection including a measurement of a refractive index distribution of a glass.

2. The process for producing a chemically strengthened glass according to claim 1, further comprising chemically strengthening a glass found to have no refractive index distribution as a result of the measurement of the refractive index distribution in the sampling inspection.

3. The process for producing a chemically strengthened glass according to claim 1, further comprising measuring a surface compressive stress and a depth of a compressive stress layer of a chemically strengthened glass in a non-destructive manner.

4. The process for producing a chemically strengthened glass according to claim 2, further comprising measuring a surface compressive stress and a depth of a compressive stress layer of a chemically strengthened glass in a non-destructive manner.

5. The process for producing a chemically strengthened glass according to claim 1, wherein the refractive index distribution is measured by means of a two-beam interferometer.
